(19) United States
(12) Patent Application Publication
(10) Pub. No.: US 2026/0270928 A1
(43) Pub. Date: Sep. 10, 2026

(54) NETWORK CONNECTIVITY BASED ON PREDICTED DEVICE ACTIVITY

(71) Applicant: T-Mobile USA, Inc., Bellevue, WA (US)

(72) Inventors: Volha Smolskaya, Lynnwood, WA (US); Zohebulla Bangalore Sanaulla, Everett, WA (US); Himangshu Chowdhury, Seattle, WA (US)

(21) Appl. No.: 19/071,641

(22) Filed: Mar. 5, 2025

(51) Int. Cl. H04W 64/00; G01S 11/06; H04W 12/06

(52) U.S. Cl. CPC H04W 64/00; G01S 11/06; H04W 12/06

(57) ABSTRACT

Techniques for determining access for a device to a telecommunications network based on prediction data associated with the device are described herein. The telecommunications network can implement a computing device to predict one or more activities the UE is likely to execute in the future. The computing device can analyze historical UE activity and coverage data indicating types of services available in different areas of the telecommunications network. The computing device can select a communication channel from a set of communication channels based on the analysis to optimize computational resources available to the network element and/or to the UE in the future.

### BACKGROUND

Modern terrestrial telecommunication systems include heterogeneous mixtures of second, third, and fourth generation (2G, 3G, and 4G) cellular-wireless access technologies, which can be cross-compatible and can operate collectively to provide data communication services. Global Systems for Mobile (GSM) is an example of 2G telecommunications technologies; Universal Mobile Telecommunications System (UMTS) is an example of 3G telecommunications technologies; and Long Term Evolution (LTE), including LTE Advanced, and Evolved High-Speed Packet Access (HSPA+) are examples of 4G telecommunications technologies. Telecommunications systems may include fifth generation (5G) cellular-wireless access technologies to provide improved bandwidth and decreased response times to a multitude of devices that may be connected to a network.

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference numbers in different figures indicates similar or identical items or features.

FIG. 1 depicts an example network environment in which an example device can connect to a telecommunications system that includes an example access management system to implement the techniques described herein.

FIG. 2 depicts an example system architecture for a fifth generation (5G) telecommunication network.

FIG. 3 depicts another example network environment in which an example user equipment can connect to a telecommunication system that includes an example access management system to implement the techniques described herein.

FIG. 4 depicts a flowchart of an example process for selecting a communication channel for a user equipment by an example access management system based on prediction data.

FIG. 5 depicts an example system architecture for a user equipment.

### DETAILED DESCRIPTION

This application relates to techniques for determining access for a device to a telecommunications network. The techniques can include a system that controls access of the device to a network element (e.g., a base station, a transceiver, or the like) based on predicted device activity associated with one or more predicted locations. The system can, for example, determine a communication channel for the device to use for a communication session with a network element, such as a base station. In some examples, the system can determine communication channels for use at different locations to maintain the communication session as the device changes location. The communication channels can be associated with different power output levels to cause the device to use a corresponding amount of power to connect to the network. By dynamically assigning communication channels, the system can limit power consumption by the device and optimize availability of computational resources (e.g., power, memory, and/or processor resources) for the device. The techniques can also improve the telecommunications network by assigning communication channels that improve overall network capacity, power usage (e.g., lowers transmission power), quality of service, latency, etc. (e.g., by the network element providing the communication channel).

In examples, the device can output different amounts of power to transmit (e.g., send or receive) messages with a network element of the telecommunications network. A battery coupled to the device provides power for the device to transmit the messages, execute an application, or otherwise operate (when not connected to an alternative power source). The techniques described herein can optimize availability of computational resources coupled to the device so that the device operates for a greater length of time in areas having varying signal strength values. In some examples, the system can proactively send a message to the device to cause the device to change to a communication channel that lowers and/or raises an amount of power required by the device to exchange data with the telecommunications network using the communication channel.

By way of example and not limitation, a wearable device such as a smart watch can include a battery having limited available computational resources to operate in a telecommunications network. Another device, such as a smart phone, can have authority to operate the smart watch (e.g., determine settings of the smart watch, authorize a network for the smart watch to connect to a network, etc.). The system can determine a communication channel for the smart watch to manage the computational resources of the smart watch over time. In some examples, the system can predict when the smart watch will change locations, and which services, applications, etc. is likely to operate on the smart watch at the future locations, and select a communication channel for a network element to provide a communication session to the smart watch that optimizes power, processor, and/or memory resources (e.g., for the smart watch to use the communication channel). In some examples, the system can send a message to the smart phone indicating a future impact to the communication session (e.g., change in signal strength, low battery, etc.), and receive an indication from the smart phone to use a particular network to avoid the future impact.

In some examples, the techniques can include optimizing network performance and/or device performance by dynamically determining communication channel(s) for exchanging data with a device that traverses an environment served by the telecommunications network. In some examples, the system can proactively assign communication channels for the device to use in different areas served by the telecommunications network based on a mapping between previous device activity and signal strength information at the location(s) of the previous device activity. The mapping can be used as input data to a machine learned model that is trained to select a communication channel from a set of communication channels. Each of the communication channels in the set of communication channels can be associated with predetermined amounts of power output by the network element (e.g., a base station). In some examples, each respective communication channel may be associated with metadata indicating a range of power values to use, configure, or connect to the respective communication channels. By selecting a communication channel having a particular power output value (or range of values), the system can control an amount of power that the device is required to output to “connect” or otherwise utilize the communication channel. Thus, by determining which communication channels to use at different times in the future, the system can cause the device to use different amounts of the computational resources coupled to the device.

The system can select a communication channel based on a variety of input data. For example, the system can receive predicted activity of a device, historical activity of the device, historical activity of a network element, coverage data indicating network elements associated with areas of a telecommunications network, a current location of the device, a time of day, to name a few. In various examples, the system can implement one or more models to analyze the input data and select a communication channel that causes the device to output a predetermined amount of power to exchange data using the selected communication channel. Selecting a particular communication channel that is configured for a network element to output a certain power range can, in some examples, cause a battery of the UE to use less power to exchange data with the network element (e.g., less transmission power, fewer processes to process, etc.). Thus, the techniques can improve battery capacity of the device while also reducing an amount of computational resources required by the network element to provide a communication session.

Generally, a battery may provide power to a receiving antenna, a transmitting antenna, a display, a speaker, a processor, a microphone, and/or other components of a device. Battery activity (or usage) can vary over time based on a location of the device, a number of applications or services being used, etc. For example, the device may require more power when not connected to WiFi and/or to increase signal strength due to obstacles between the device and the network element. In some examples, the battery may increase power output by an antenna due to the device being indoors, in a tunnel, or the like to maintain a communication session. Battery activity, signal strength, etc. may also or instead vary due to user interaction with the device, applications executing by the device, services used for exchanging data, and so on. In some examples, the system can implement a machine learned model to predict which activities and associated computational resources a device is likely to use at a particular location and time in the future with consideration to the power desired by the device over time.

The techniques described herein can reduce or eliminate instances when the device operates in “low power mode” or the battery is unable to provide power by proactively determining communication channels over time in accordance with the changing location and characteristics of the device (e.g., battery capacity, applications to be used in the future, etc.). In some examples, an access management system can determine a communication channel (from a set of available communication channels) for exchanging data that requires the device to use less of the available battery capacity relative to using another communication channel that is configured to use more power from the battery to exchange data. Additional discussion of selecting a communication channel can be found throughout this disclosure including in the figures below.

In some examples, the access management system can determine parameters for the network element that causes a reduction in power consumption by the device thereby improving performance of the device. For example, an analysis component of a computing device can receive device information (e.g., previous signal strength output relative to a location and time) and determine parameters for one or more network elements to exchange data with the device. In some examples, the parameters of the network element can represent one or more of: downlink power, uplink power, number of downlink transmitters, number of uplink transmitters, numbers of concurrently connected users, cell radius, and so on.

The computing device can, in some examples, determine metadata for each respective communication channel indicating power output, battery requirements of a device, etc. The computing device can assign, select, or identify one or more of the communication channels for use at a particular time by the device based on remaining power capacity of the device and the metadata for the communication channels. The system can receive the metadata as input for determining which communication channel optimizes the computational resources of the device at a particular time.

The techniques described here can improve device performance in a variety of ways. For example, an access management system can provide communication channel(s) that improve battery performance, processor performance, memory availability, etc. of the device. In some examples, the device can send device information (e.g., signal strength data, battery data, etc.) in a message to the access management system for consideration in determining a communication channel for exchanging data. Additional discussion of managing device access by a component or system associated with a telecommunications network can be found throughout this disclosure including in the figures below.

In some examples, the network element can represent, for example, a base station (e.g., a gNodeB (gNB)), a transceiver, an antenna, a relay point, an access point, a serving node, a computing device (e.g., a server), or other entity of the telecommunications network. The techniques described herein can be used to control which network elements are accessed by a device based on predicted activity associated with the device. For instance, an access management system of a computing device can optimize settings or parameters for one or more network elements (e.g., adjust power output for one or more network elements) to increase available computational resources to the device.

The access techniques described herein can improve a computing device and/or network in a variety of ways. Quality of service, network bandwidth, etc. can be improved by managing access to a device with consideration to computational resources associated with the device. For instance, a UE can receive service from a network element based on levels of power, processing, or memory available to the device with consideration to predicted activity the device is likely to use in the future. The techniques may also improve availability of computational resources (e.g., network elements, processing resources, memory resources, and the like) to the telecommunications network by limiting use of processor, memory, and/or power resources available to the telecommunications network.

Though some examples are described in relation to a computing device, in various examples one or more computing devices, UEs, networks, or other entities may perform or otherwise be associated with the techniques described herein. In various examples, the device may be configured with instructions to implement the techniques described herein. For example, the device can be configured with the instructions to cause the device to use a particular network element for transmitting a first message to a particular server, base station, or network (e.g., a core network).

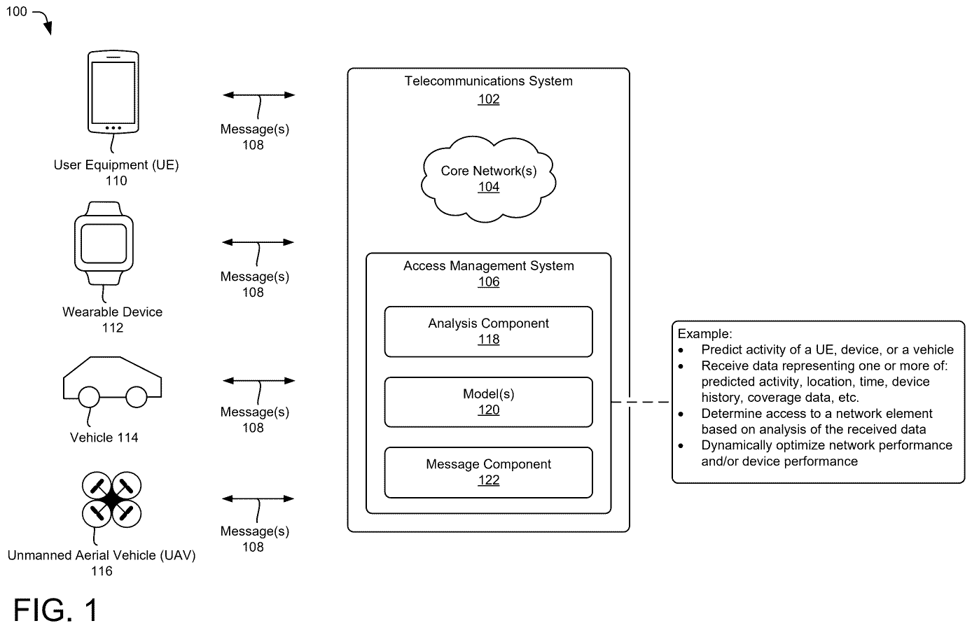

FIG. 1 depicts an example network environment 100 in which example devices can connect to a telecommunications system that includes an example access management system to implement the techniques described herein. As shown in FIG. 1, the telecommunications system 102 includes one or more core networks 104 (may also be referred to as the core network 104 or the core network(s) 104) for exchanging data and an access management system 106 that is configured to determine access to the core network(s) 104. For example, the telecommunications system 102 can exchange one or more messages 108 (may also be referred to as the message 108 or the message(s) 108) with a device(s) such as one or more of: a user equipment (UE) 110, a wearable device 112, a vehicle 114, an unmanned aerial vehicle (UAV) 116, or other device.

Though some example devices are shown in FIG. 1 for example purposes, other device types may also or instead be included in examples. For instance, the techniques described herein can be used to control access for any device that can wirelessly connect to the telecommunication network, and in some examples may include a mobile phone, a sensor, a personal digital assistant (PDA), a personal computer (PC) such as a laptop, desktop, or workstation, a media player, a tablet, a gaming device, an access point, a relay point, a smart watch, a hotspot, a Machine to Machine device (M2M), a vehicle (e.g., an autonomous vehicle, an unmanned aerial vehicle, airplane, boat, etc.), an Internet of Things (IoT) device, or any other type of computing or communication device.

The core network 104 can, for example, represent a 5G network though other core network types may also be used (e.g., past or future generation networks such as a sixth generation (6G) network).

The access management system 106 may represent firmware, hardware and/or software that generates, assigns, selects, or otherwise determines a communication channel(s) for a device to connect to the telecommunications system 102. The access management system 106 may, for example, predict device activity at different locations in the future and determining a communication channel(s) between the device and a network element for the different locations based at least in part on the predicted device activity. In various examples, the network element can represent a base station (e.g., a gNB), a transceiver, an antenna, a relay point, an access point, a serving node, a computing device (e.g., a server), just to name a few. In some examples, the access management system 106 can select a communication channel from a set of communication channels for an entity to exchange data with the core network(s) 104.

The message(s) 108 can represent a communication or an exchange of data between one or more of: the UE 110, the wearable device 112, the vehicle 114, or the UAV 116 and the core network 104. In some examples, the message(s) 108 may be associated with a request to place a call, access a service, or otherwise connect to the telecommunications system 102. The message 108 may, for example, represent a communication between the UE 110 and the wearable device 112 (e.g., a smart watch, clothing, etc.).

As shown in FIG. 1, the access management system 106 includes an analysis component 118, one or more models 120, and a message component 122. Though the analysis component 118, the one or more models 120, and the message component 122 are illustrated in FIG. 1 individually, it is understood that the analysis component 118, the one or more models 120, and the message component 122 (or functionality provided therefrom) may be directly coupled to and/or integrated into a single component or computing device (including in some examples the UE 110 or another device).

The access management system 106 can receive input data and implement the analysis component 118 and/or the model(s) 120 to generate output data representing a communication channel for exchanging data with a device. For example, analysis component 118 can provide functionality to analyze the input data to determine a communication channel that can provide a predicted service for the device at a predicted location. For example, the wearable device 112 can operate in different areas of the telecommunications system 102 in the future, and the analysis component 118 can identify communication channels for the different areas that maximizes the available computational resources to the device over the time that the device operates in the different areas. In some examples, the model(s) 120 can predict activities that the device is likely to use at a future time including applications, services, and the like.

In various examples, the input data can comprise one or more of: predicted activity (e.g., of the device and/or a network element), a predicted location for the predicted activity of the device, historical activity (e.g., of the device and/or the network element), coverage data indicating areas having particular levels or types of service, mapped data indicating a mapping between previous device activity and signal strength information at the location(s) of the previous device activity, a current location of the device, a current time, to name a few. The model(s) 120 can determine the predicted activity of the device based on historical activity detected or otherwise provided by the device at a previous time. The model(s) 120 may also or instead output the mapped data at various times as the previous device activity changes.

In various examples, the model(s) 120 that may be representative of machine learned models, non-machine learning models, or a combination thereof. As described herein, a model may refer to a machine learning model that learns from a training data set to improve accuracy of an output (e.g., a prediction). Additionally or alternatively, a model may represent logic and/or mathematical functions that generate approximations which are usable to make predictions (e.g., a heuristic model, a statistical model, etc.).

In some examples, the model(s) 120 can predict activity of the UE 110, the wearable device 112, the vehicle 114, and/or the UAV 116 at a future time (e.g., determine which applications, services, etc. will likely be used in the future, and a predicted power demand in the future). For instance, the model(s) 120 can represent a machine learned model that is trained to predict communication channels for use that collectively optimize device performance over time and use the predictions to determine access for the UE 110, the wearable device 112, the vehicle 114, and/or the UAV 116 to the network element.

The model(s) 120 may, in examples, determine metadata for the device (or a computational resource thereof) and/or the network element describing settings over a previous time period. In some examples, the metadata can represent signal strength data during previous activity associated with the UE (e.g., historical data). The historical data can represent device data such as battery capacity at different times and/or historical device activity data such as services accessed, applications accessed, etc. In some examples, the model(s) 120 can associate a communication channel with channel specific metadata to provide criteria for using or selecting various communication channels.

In some examples, the analysis component 118 can employ the message component 122 to send a message 108 to cause the device to access a network element using the communication channel output by the access management system 106 (or a model or component thereof). For example, the message 108 can include an indication to use a particular communication channel for a communication session. The message component 122 can send and/or receive messages between a) components and/or models of the access management system, b) other components and models of the telecommunications system 102, or c) one or more of the example devices of FIG. 1. In some examples, the message component 122 can receive the message 108 from the UE 110 indicating preferences for the UE 110 and/or for the wearable device 112 (when authorized as discussed herein). For example, the message component 122 can receive the message 108 indicating network preferences that can be included as part of profile data which is usable as input data. The network preferences can indicate a ranked list of networks the wearable device 112 can use in the future. The ranked list of networks can include wireless carrier networks (e.g., 5G networks, 6G networks, etc.), a Bluetooth network, a WiFi network, or the like.

In some examples, the system can predict when the wearable device 112 is likely to change locations and which services, applications, etc. the wearable device 112 is likely to use at the future time. The time to change locations and/or use certain service, applications, etc. can be considered by the analysis component 118 to select a communication channel(s) for one or more network elements to provide a communication session to the wearable device 112 that optimizes power, processor, and/or memory resources (e.g., for the smart watch to use the communication channel) so that the wearable device 112 operates for a greater length of time due to the wearable device 112 changing locations.

In some examples, the techniques can include optimizing network performance and/or device performance by dynamically determining communication channel(s) for exchanging data with the device as the device traverses an environment served by the telecommunications system 102. In some examples, the system can proactively assign communication channels for a device (such as one of: the UE 110, the wearable device 112, the vehicle 114, or the UAV 116) to use in different areas served by the telecommunications network based on a mapping between previous device activity and signal strength information at the location(s) of the previous device activity.

In various examples, the access management system 106 can, based at least in part on the predicted activity data, send instructions to the network element to change a parameter, setting, etc. of the network element. In some examples, the change in parameter, setting, etc. can cause the network element to change power output, tilt angle, a number of carriers, and/or a number of layers, to name a few. In some examples, the instructions can be used to control operation of the network element to require lower power output by the device to access the network element.

Output data from the access management system 106 can be used to optimize power, processor, and/or memory resources which may include optimizing battery efficiency of a battery coupled to a device. For example, the output data can indicate which communication channel to use at different times, and change communication channels over time dynamically in accordance with changes in device data (e.g., signal strength, battery capacity, predicted activity, etc.). By dynamically changing communication channels over time as described herein, a communication session with the device can transition between the multiple communication channels during the communication session to maintain communication session as the device operates in areas with different signal strength, battery capacity, etc.

To implement the techniques described herein, in various examples the telecommunications system 102 and/or the access management system 106 can include one or more of: an a proxy call session control function (P-CSCF), an interrogating call session control function (ICSCF), a serving call session control function (SCSCF), a serving gateway (SGW), a packet data network gateway (PGW), a policy and charging rules function (PCRF), and an internet protocol short message gateway (IPSM-GW), a short message service center (SMSC), and an evolved packet data gateway (ePDG), and a Home Subscriber Server (HSS), just to name a few. In addition, the techniques described herein may be implemented using Real-Time Protocol (RTP) and/or Real-Time Control Protocol (RTCP), among others.

In various examples, the telecommunications system 102 (e.g., a 5G system) can represent functionality to provide a communication channel for the UE 110, the wearable device 112, the vehicle 114, and/or the UAV 116 and can include one or more radio access networks (RANs), as well as one or more core networks linked to the RANs. For instance, the UE 110, the wearable device 112, the vehicle 114, and/or the UAV 116 can wirelessly connect to a base station or other access point of a RAN, and in turn be connected to the core network (e.g., a 5G core network). The RANs and/or core networks can be compatible with one or more radio access technologies, wireless access technologies, protocols, and/or standards. For example, wireless and radio access technologies can include fifth generation (5G) technology, Long Term Evolution (LTE)/LTE Advanced technology, other fourth generation (4G) technology, third generation (3G) technology, High-Speed Data Packet Access (HSDPA)/Evolved High-Speed Packet Access (HSPA+) technology, Universal Mobile Telecommunications System (UMTS) technology, Global System for Mobile Communications (GSM) technology, WiFi technology, and/or any other previous or future generation of radio access technology. In this way, the telecommunications system 102 is compatible to operate with other radio technologies including those of other service providers. Accordingly, the message(s) 108 associated with the UE 110, the wearable device 112, the vehicle 114, and/or the UAV 116 may originate with another service provider (e.g., a third-party) and be processed by the access management system 106 independent of the technolog(ies) or core network associated with the service provider.

In some examples, the access management system 106 can be included in or otherwise represent a computing device that determines access for a device based on predicted activity and the RAN can wirelessly connect the device to the core network(s) 104 based on the predicted activity by considering the predicted activity when determining a communication channel or settings thereof (e.g., power control settings, a number of carriers, a number of layers, etc.).

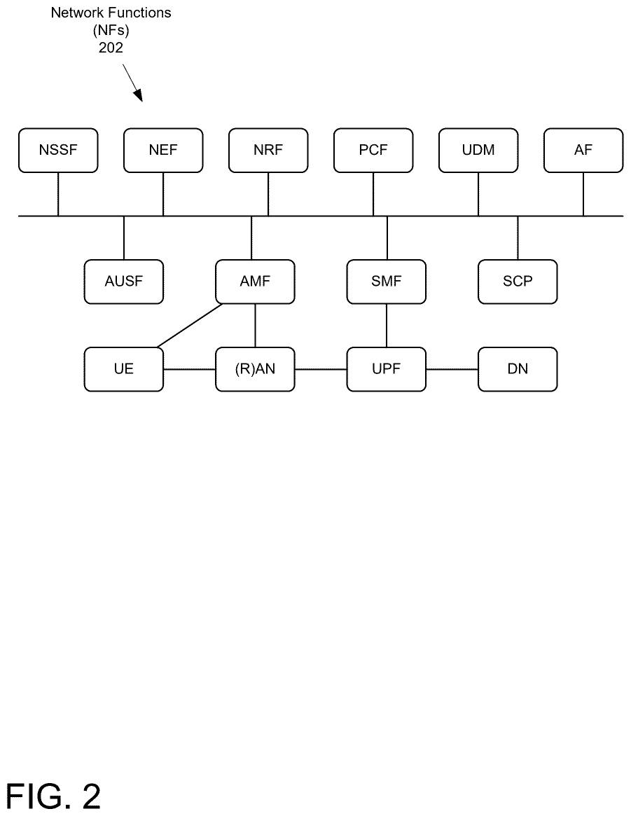

In some examples, the core network 104 can represent a service-based architecture that includes multiple types of network functions that process control plane data and/or user plane data to implement services for the UE 110, the wearable device 112, the vehicle 114, and/or the UAV 116. In some examples, the services comprise rich communication services (RCS), a VoNR service, a ViNR service, and the like which may include a text, a data file transfer, an image, a video, or a combination thereof. The network functions of the core network 104 can include an Access and Mobility Management Function (AMF), a Session Management Function (SMF), a User Plane Function (UPF), a Policy Control Function (PCF), and/or other network functions implemented in software and/or hardware, just to name a few. Examples of network functions are also discussed in relation to FIG. 2, and elsewhere.

FIG. 2 depicts an example system architecture for a fifth generation (5G) telecommunication network. In some examples, the 5G telecommunication network can comprise the core network 104 in FIG. 1 that includes a service-based system architecture in which different types of network functions (NFs) 202 operate alone and/or together to implement services. Standards for 5G communications define many types of NFs 202 that can be present in 5G telecommunication networks (e.g., the 5G core network), including but not limited to an Authentication Server Function (AUSF), Access and Mobility Management Function (AMF), Data Network (DN), Unstructured Data Storage Function (UDSF), Network Exposure Function (NEF), Network Repository Function (NRF), Network Slice Selection Function (NSSF), Policy Control Function (PCF), Session Management Function (SMF), Unified Data Management (UDM), Unified Data Repository (UDR), User Plane Function (UPF), Application Function (AF), User Equipment (UE), (Radio) Access Network ((R)AN), 5G-Equipment Identity Register (5G-EIR), Network Data Analytics Function (NWDAF), Charging Function (CHF), Service Communication Proxy (SCP), Security Edge Protection Proxy (SEPP), Non-3GPP InterWorking Function (N3IWF), Trusted Non-3GPP Gateway Function (TNGF), and Wireline Access Gateway Function (W-AGF), many of which are shown in the example system architecture of FIG. 2.

One or more of the NFs 202 of the core network 104 can be implemented as network applications that execute within containers (not shown). The NFs 202 can execute as hardware elements, software elements, and/or combinations of the two within telecommunication network(s), and accordingly many types of the NFs 202 can be implemented as software and/or as virtualized functions that execute on cloud servers or other computing devices. Network applications that can execute within containers can also include any other type of network function, application, entity, module, element, or node.

The core network 104 can, in some examples, determine a connection between an IMS that manages a communication session for the device, including sessions for short messaging, voice calls, video calls, and/or other types of communications. For example, the device and the IMS of the telecommunications system 102 can exchange Session Initiation Protocol (SIP) messages to set up and manage individual communication sessions. Different types of communications can, in some examples, utilize different communication channels which can be associated with different network element settings such as different power output by the network element and subsequently the device.

Though some examples in FIG. 1 and elsewhere are described in association with a 5G telecommunication system, the techniques described herein can be used in other telecommunication system types include past generation and/or future generation telecommunication systems.

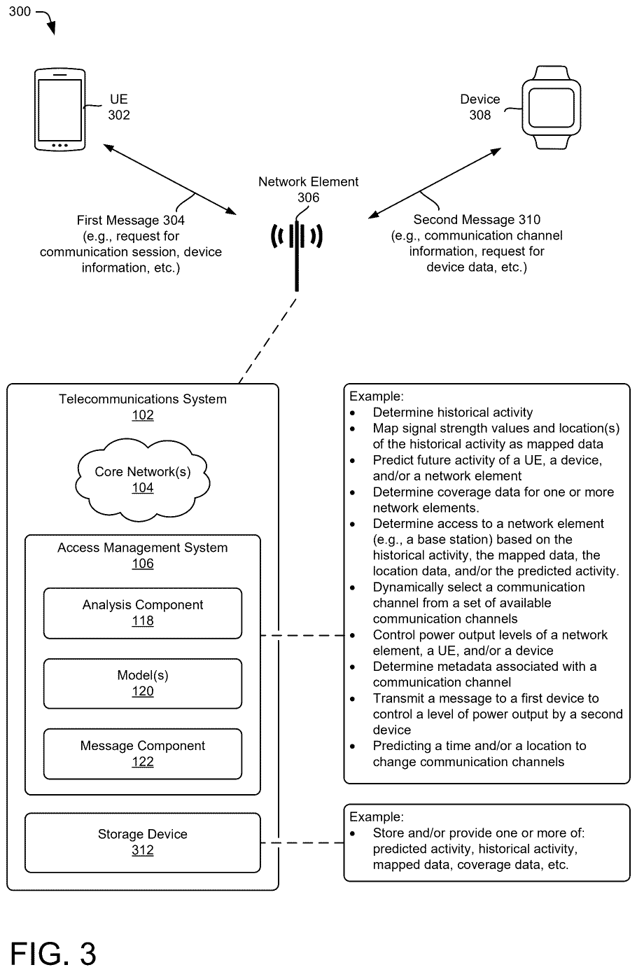

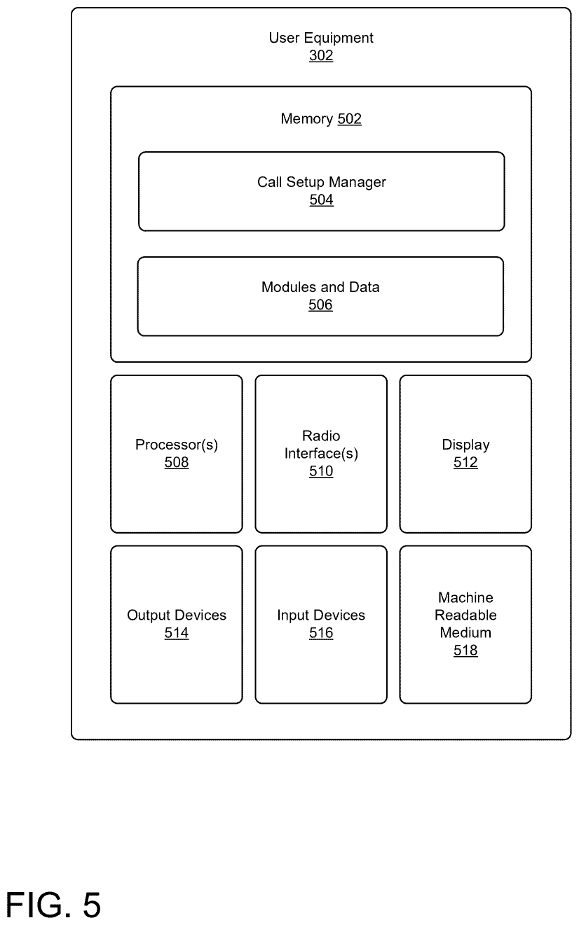

FIG. 3 depicts another example network environment 300 in which an example user equipment can connect to a telecommunication system that includes an example access management system to implement the techniques described herein. For example, a UE 302 can send a first message 304 to a network element 306 of the telecommunications system 102 requesting a communication session, and the access management system 106 can select a first communication channel between the network element 306 and the UE 302. The UE 302 can, in some examples, include at least the functionality of the UE 110 of FIG. 1. An example architecture for the UE 302 is illustrated in greater detail in FIG. 5. FIG. 3 further illustrates a device 308 exchanging a second message 310 with the network element 306 (e.g., using a second communication channel).

FIG. 3 illustrates the telecommunications system 102 comprising a storage device 312 to store and/or provide various types of data. For example, the storage device 312 can store input data and/or output data associated with the access management system 106 including predicted activity, mapped data, coverage data, historical activity associated with the UE 302, the device 308, and/or the network element 306, communication channels assigned to the UE and/or the device 308 for specific locations, to name a few.

The first message 304 can represent a request for a communication from the UE 302, device information indicating previous activity by the UE 302, or communication channel information sent from the network element 306 to enable the UE 302 to access the network element 306 for the first communication session, etc. In some examples, the second message 310 can include communication channel information sent from the network element 306 to enable the device 308 to access the network element 306 for the second communication session. The second message 310 may also or instead include a request for device data from the network element 306 or device data sent from the device 308 to provide current diagnostics of the computational resources (e.g., current battery capacity, services being executed, etc.). In some examples, the device data can include a current location, time, battery capacity, signal strength, or other usage data. In some examples, the first message 304 can include a request for a communication session (e.g., place a call, use an application, etc.). In some examples, the first message 304 and/or the second message 310 can be sent to the network element 306 to report device data at pre-determined intervals.

In some examples, the access management system 106 can send the second message 310 to the device 308 to indicate a communication channel for use and/or to request device data (e.g., levels of power, processor, and/or memory resources available to the device 308). For instance, the message component 122 can configure the first message 304 for sending to the UE 302 and the second message 310 for sending to the device 308.

In some examples, the first message 304 and/or the second message 310 can include profile data indicating preferences for whether to utilize battery saving techniques when connecting to a telecommunications network. The profile data can indicate authorized networks for a particular device, a ranked list of applications or services to receive power, applications or services having access to the battery regardless of the battery saving techniques, and so on. The profile data may be associated with a previous time (e.g., historical activity by the UE), a current time (e.g., applications or services or other activity currently executed by the UE), or a future time (e.g., predicted activity by the UE over a future time period determined by the model(s) 120).

The network element 306 can represent a base station (e.g., a gNB), a transceiver, an antenna, a relay point, an access point, a serving node, a computing device (e.g., a server), or other portion of the core network(s) 104. The network element 306 can be configured to provide a set of communication channels each being associated with different parameters or settings of the network element 306. For example, the communication channels can be available to provide different bandwidth for devices at a threshold distance from the network element 306.

The access management system 106 can, in examples, dynamically select a communication channel from a set of available communication channels for the network element 306 and optionally additional network elements. The communication channels selected over time can be associated with different power output levels by the network element 306. By controlling the power output of the network element 306, the access management system 106 can further control power output levels in the UE 302 or the device 308 to use the communication channels. By determining communication channels over time as described herein, the UE 302 and/or the device 308 can maximize battery capacity for a greater length of time. That is, a battery of the UE 302 and/or the device 308 can be available for longer periods of time by managing the power required for the UE 302 to use a corresponding communication channel.

Selecting a communication channel can be based on a variety of criteria including, for example, the analysis component 118 may receive one or more of: historical services, applications, etc. used by the UE 302 or the device 308, mapped data representing a mapping between signal strength values at location(s) of the historical activity, predicted activity for the UE 302 and/or the device 308, predicted activity for the network element 306 (e.g., predicted bandwidth), coverage data indicating regions of an environment that are servable by one or more network elements. In some examples, the analysis component 118 can receive the coverage data for determining that a predicted location of the device 308 is within a boundary of a second network element and that the second network element includes a range of power output levels for a set of communication channels that is lower than a current range of power output levels associated with the first network element. The analysis component 118 can determine a communication channel for the device 308 prior to the device 308 entering the boundary of the second network element. Such determination of the communication channel may include utilizing another device, such as the UE 302, or another UE proximate the device 308 to cause the device 308 access to the network element 306 via a communication channel that is used by the UE 302 or the proximate UE to communicate with the network element 306.

In some examples, the analysis component 118 can output parameters or settings for the network element 306 to cause the UE 302 to receive service from the network element 306 (e.g., power output information for the network element 306) and transmit the power output information to the network element 306. The analysis component 118 may also or instead determine parameters associated with a tilt angle, a frequency, and/or other characteristics of the network element 306.

In various examples, the model(s) 120 can predict activity that the UE 302 and/or the device 308 is likely to execute at a future time (e.g., identify applications, services, etc.) and further predict power demand required by the UE 302 and/or the device 308 at the future time. For instance, the model(s) 120 can represent a machine learned model that is trained to predict services for use at specific locations and a same or different machine learned model to predict or identify potential impacts to the computational resources of the device. In some examples, the model(s) 120 can estimate an amount of computational resources for the UE to perform the predicted activity(ies) and select a communication channel based at least in part on the estimated amount of computational resources for the UE to perform the predicted activity(ies).

The access management system 106 can mitigate the potential impacts to the computational resources of the device by managing power consumption through proactively assigning communication channels for the UE 302 and/or the device 308 to access the network element 306 based on the predicted potential impacts. For example, the machine learned model can predict a value representing a likelihood of an impact to a power resource (e.g., battery), processor resource, and/or memory resource and output the value for use as input data into the analysis component 118 that configures the network element 306 to provide service to the UE 302 and/or the device 308 that ensures battery capacity can be available at a later time.

In some examples, the predicted activity output by the model(s) 120 can indicate an amount of data or type of data associated with an application or a service for use by the UE at a future time. The analysis component 118 can, in some examples, restrict a communication channel in a set of communication channels from being used by the UE 302 based on the amount of data and/or the type of activity at the predicted location. For example, the predicted activity for UE 302 can indicate that the UE 302 is likely to open an application that may include exchanging video at a particular future time while the UE 302 is located inside a building. The analysis component 118 can restrict the UE 302 from using one or more communication channels having characteristics (e.g., power output, bandwidth, battery capacity requirements, etc.) that would prevent the UE 302 from exchanging video data in the future time. The analysis component 118 may also select communication channel(s) for use by the UE 302 and/or restrict other communication channel(s) from being used by the UE 302 for other predicted locations at one or more earlier times to conserve the computational resources for use by the UE 302 at these predicted locations.

In some examples, the model(s) 120 can determine metadata associated with a communication channel including identifying a range of battery capacities, power output levels, or other value required for determining whether to select the communication channel for the UE 302 and/or the device 308 at a particular time. Metadata can be updated over time to maintain a description for the communication channels in a set of communication channels, and differences between the channels such as a bandwidth provided, power required, and the like.

By way of example and not limitation, the UE 302 can represent a smart phone associated with a first user (e.g., a parent) and the device 308 can represent a smart watch associated with a second user (e.g. a child). In examples, the UE 302 can have authority to determine network connections for the device 308 as the second user traverses an environment. For example, in examples when the device 308 approaches an area with limited (e.g., bandwidth below a threshold) or no service from a nearby network element, the message component 122 can send the first message 304 to the UE 302 to notify the first user that the second user is approaching an area and there is a potential impact to service. In some examples, the UE 302 can send a message to the access management system 106 indicating a network available via a third device (e.g., a teacher of the child, a third-party device or network, etc.) while in other examples the UE 302 can otherwise be aware that the device 308 may be unavailable until it reaches a new serviceable location. In some examples, the UE 302 can prevent the device 308 from searching for signals which drains the battery of the device when the device 308 is in an area without service.

In some examples, the message component 122 can send a message to the UE 302 and cause a list of networks available to the device 308 to be displayed on a display device of the UE 302 (e.g., for selection by the first user). However, in other examples the analysis component 118 can select a communication channel for the device 308 automatically and without requiring a message from the UE 302 based on previously receiving authority by the UE 302 to control a predetermined list of networks for the device 308. The predetermined list of networks can include third-party devices (e.g., a teacher, field trip supervisor, etc.) that can provide a communication channel to the network element 306.

The model(s) 120 can, in some examples, predict a time and/or a location at which to transition from the UE 302 and/or the device 308 using a first communication channel at a first time to using a second communication channel at a second time. Over time transition between communication channels can be optimized based on historical locations, activities, batter capacities, etc.

In various examples, output data from the access management system 106 can be stored in the storage device for access at a later time. For example, the storage device 312 can receive data representing previous output data by the access management system 106 for storage and make such data available to a component, device, etc. for processing at a later time (e.g., for analysis, training, etc.).

The storage device 312 can provide functionality to store and/or provide data associated with the network element 306, the UE 302, or the device 308 usable for providing the techniques described herein. For example, the storage device 312 can receive, store, and/or provide device data, historical activity, predicted activity, mapped data, coverage data, metadata, and/or profile data, to name a few. In some examples, the storage device 312 can provide prediction data, current location data, etc. to the access management system 106. The access management system 106 (or component thereof) may, for example, exchange data with the storage device 312 (e.g., a memory, a database, etc.) to implement the access techniques described herein.

In various examples, the storage device 312 can represent a Unified Data Management (UDM) to manage user data and/or an Authentication Server Function (AUSF) to manage authorization for the UE 302 and/or device 308 (e.g., in a 5G system). However, in examples when the core network 104 is different from 5G, such as 4G, the storage device 312 can represent a Home Subscriber Server (HSS). Thus, the storage device 312 can represent a subscription management entity depending upon a type of the core network 104 used to employ the techniques.

In various examples, the access management system 106 can be coupled to the network element 306 or other portion of the telecommunications system 102. Additionally, or alternatively, the access management system 106 can be centrally located and represent a server or other computing device.

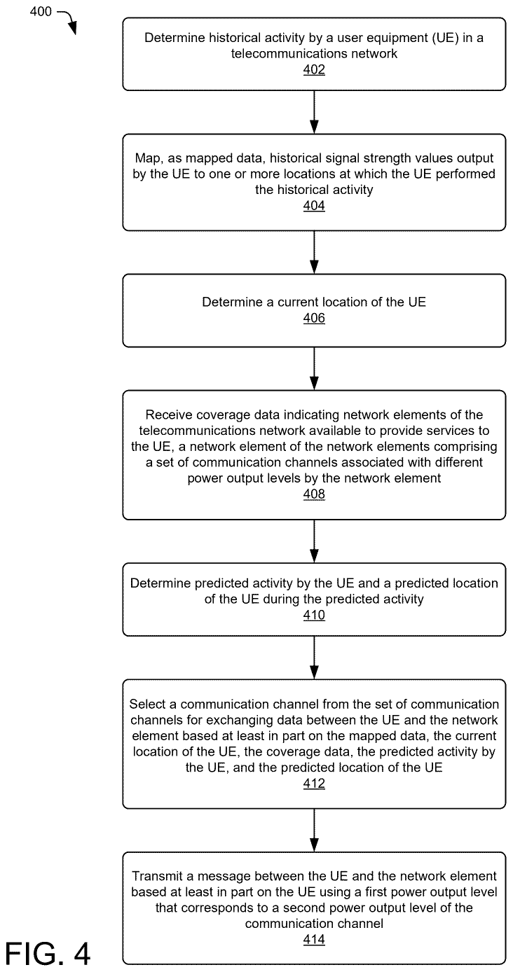

FIG. 4 depicts a flowchart of an example process 400 for selecting a communication channel for a user equipment by an example access management system based on prediction data. Some or all of the process 400 may be performed by one or more components in FIGS. 1-3, as described herein. For example, some or all of process 400 may be performed by the access management system 106 of FIG. 1. In some examples, a communication channel can be determined for a UE that controls an amount of power output by the UE.

At operation 402, the process may include determining historical activity by a user equipment (UE) in a telecommunications network. For example, analysis component 118 can determine activities associated with the UE 302 while connected to or attempting to connect to a core network (e.g., the core network(s) 104). In some examples, the operation 402 may include the access management system 106 receiving historical activity data from the UE 302 and/or from the storage device 312. In various examples, the historical activity can indicate which services, applications, etc. were executed by the UE 302 relative to one or more network elements. The access management system 106 may, for instance, receive a message (e.g., the first message 304) from the UE 302 to establish or maintain a voice, video, and/or text communication session and determine the UE historical activity based on information in the message. In some examples, the network element can represent a base station for providing service to the UE 302.

At operation 404, the process may include mapping, as mapped data, historical signal strength values output by the UE to one or more locations at which the UE performed the historical activity. For instance, the access management system 106 can identify, detect, or otherwise determine the signal strength associated with the UE 302 at various locations at which particular service or applications were executed. In examples when the UE 302 changes position over time, the access management system 106 can analyze new messages exchanged with the UE 302 to detect new device data (e.g., new signal strength, change in battery capacity, etc.) associated with one or more messages at different times. In some examples, the mapped data can represent which signal strengths were used to connect to previous communication channels for specific locations. The mapped data can indicate signal strength patterns for the UE over time.

At operation 406, the process may include determining a current location of the UE. In some examples, the operation 406 may include the access management system 106 identifying a location of the UE 302 based on a message, a signal, or other data received from the UE 302. For example, the telecommunications system 102 can use a variety of location techniques to determine a location of the UE at a current time.

At operation 408, the process may include receiving coverage data indicating network elements of the telecommunications network available to provide services to the UE, a network element of the network elements comprising a set of communication channels associated with different power output levels by the network element. The coverage data can indicate infrastructure (e.g., network elements, a core network, etc.) available to provide service to different regions in an environment. The coverage data can associated with a region that is a threshold distance from a current location of the UE, for example.

At operation 410, the process may include determining predicted activity by the UE and a predicted location of the UE during the predicted activity. For example, the access management system 106 can implement the model(s) 120 to predict types and/or amounts of activity (e.g., executable instructions) the UE 302 is likely to execute at a future time. In various examples, the model(s) 120 can associated with the activity with corresponding predicted locations. The predicted activity can be determined by the model(s) 120 based at least in part on historical activity by the UE corresponding to various locations, times, etc.

At operation 412, the process may include selecting a communication channel from the set of communication channels for exchanging data between the UE and the network element based at least in part on the mapped data, the current location of the UE, the coverage data, the predicted activity by the UE, and the predicted location of the UE. For example, the access management system 106 can, for example, select a communication channel for use by the UE 302 based on the analysis component 118 analyzing the mapped data, the current location, the coverage data, the predicted location, and the current time. For example, the access management system 106 can select a first communication channel over a second communication channel based on a range of power values, battery capacity values, or the like associated with the communication channel (e.g., as metadata). In some examples, the operation 412 may include the access management system 106 selecting the first communication channel based at least in part on analyzing metadata associated with respective communication channels. The communication channels may be associated with respective metadata for use in identifying characteristics of each communication channel (e.g., desired power output or battery level, etc.).

At operation 414, the process may include transmitting a message between the UE and the network element based at least in part on the UE using a first power output level that corresponds to a second power output level of the communication channel. In some examples, the operation 414 may include the access management system 106 (e.g., at a network element or other location) implementing the message component 122 to transmit the first message 304 to the UE 302 to cause the UE 302 to use the selected communication channel. In some examples a same or different instruction output by the access management system 106 can include one or more settings or parameters for modifying a mechanical tilt angle, an electronic tilt angle, power output, frequency, or the like of the network element 306.

FIG. 5 depicts an example system architecture for the UE 302, in accordance with various examples. As shown, a UE 302 can have memory 502 storing a call setup manager 504, and other modules and data 506. A UE 302 can also comprise processor(s) 508, radio interfaces 510, a display 512, output devices 514, input devices 516, and/or a machine readable medium 518.

In various examples, the memory 502 can include system memory, which may be volatile (such as RAM), non-volatile (such as ROM, flash memory, etc.) or some combination of the two. The memory 502 can further include non-transitory computer-readable media, such as volatile and nonvolatile, removable and non-removable media implemented in any method or technology for storage of information, such as computer readable instructions, data structures, program modules, or other data. System memory, removable storage, and non-removable storage are all examples of non-transitory computer-readable media. Examples of non-transitory computer-readable media include, but are not limited to, RAM, ROM, EEPROM, flash memory or other memory technology, CD-ROM, digital versatile discs (DVD) or other optical storage, magnetic cassettes, magnetic tape, magnetic disk storage or other magnetic storage devices, or any other non-transitory medium which can be used to store desired information and which can be accessed by the UE 302. Any such non-transitory computer-readable media may be part of the UE 302.

The call setup manager 504 can send and/or receive messages comprising a VoNR service, a ViNR service, and/or an RCS service including SIP messages associated with setup and management of a call session via an IMS, an AMF, or the like. The SIP messages can include an SIP INVITE message and/or other SIP messages.

The other modules and data 506 can be utilized by the UE 302 to perform or enable performing any action taken by the UE 302. The modules and data 506 can include a UE platform, operating system, and applications, and data utilized by the platform, operating system, and applications.

In various examples, the processor(s) 508 can be a central processing unit (CPU), a graphics processing unit (GPU), or both CPU and GPU, or any other type of processing unit. Each of the one or more processor(s) 508 may have numerous arithmetic logic units (ALUs) that perform arithmetic and logical operations, as well as one or more control units (CUs) that extract instructions and stored content from processor cache memory, and then executes these instructions by calling on the ALUs, as necessary, during program execution. The processor(s) 508 may also be responsible for executing all computer applications stored in the memory 502, which can be associated with common types of volatile (RAM) and/or nonvolatile (ROM) memory.

The radio interfaces 510 can include transceivers, modems, interfaces, antennas, and/or other components that perform or assist in exchanging radio frequency (RF) communications with base stations of the telecommunication network, a Wi-Fi access point, and/or otherwise implement connections with one or more networks. For example, the radio interfaces 510 can be compatible with multiple radio access technologies, such as 5G radio access technologies and 4G/LTE radio access technologies. Accordingly, the radio interfaces 510 can allow the UE 302 to connect to a 5G system and/or a 4G system (or other past or future system) as described herein.

The display 512 can be a liquid crystal display or any other type of display commonly used in UEs. For example, display 512 may be a touch-sensitive display screen, and can then also act as an input device or keypad, such as for providing a soft-key keyboard, navigation buttons, or any other type of interactive input. In some examples, the display 512 can represent a wearable device such as a headset for presenting and/or receiving data associated with a user. The output devices 514 can include any sort of output devices known in the art, such as the display 512, speakers, a vibrating mechanism, and/or a tactile feedback mechanism. Output devices 514 can also include ports for one or more peripheral devices, such as headphones, peripheral speakers, and/or a peripheral display. The input devices 516 can include any sort of input devices known in the art. For example, input devices 516 can include a microphone, a keyboard/keypad, and/or a touch-sensitive display, such as the touch-sensitive display screen described above. A keyboard/keypad can be a push button numeric dialing pad, a multi-key keyboard, or one or more other types of keys or buttons, and can also include a joystick-like controller, designated navigation buttons, or any other type of input mechanism.

The machine readable medium 518 can store one or more sets of instructions, such as software or firmware, that embodies any one or more of the methodologies or functions described herein. The instructions can also reside, completely or at least partially, within the memory 502, processor(s) 508, and/or radio interface(s) 510 during execution thereof by the UE 302. The memory 502 and the processor(s) 508 also can constitute machine readable media 518.

The various techniques described herein may be implemented in the context of computer-executable instructions or software, such as program modules, that are stored in computer-readable storage and executed by the processor(s) of one or more computing devices such as those illustrated in the figures. Generally, program modules include routines, programs, objects, components, data structures, etc., and define operating logic for performing particular tasks or implement particular abstract data types.

Other architectures may be used to implement the described functionality and are intended to be within the scope of this disclosure. Furthermore, although specific distributions of responsibilities are defined above for purposes of discussion, the various functions and responsibilities might be distributed and divided in different ways, depending on circumstances.

Similarly, software may be stored and distributed in various ways and using different means, and the particular software storage and execution configurations described above may be varied in many different ways. Thus, software implementing the techniques described above may be distributed on various types of computer-readable media, not limited to the forms of memory that are specifically described.

### Conclusion

Although the subject matter has been described in language specific to structural features and/or methodological acts, it is to be understood that the subject matter is not necessarily limited to the specific features or acts described above. Rather, the specific features and acts described above are disclosed as example embodiments.

While one or more examples of the techniques described herein have been described, various alterations, additions, permutations and equivalents thereof are included within the scope of the techniques described herein.

In the description of examples, reference is made to the accompanying drawings that form a part hereof, which show by way of illustration specific examples of the claimed subject matter. It is to be understood that other examples can be used and that changes or alterations, such as structural changes, can be made. Such examples, changes or alterations are not necessarily departures from the scope with respect to the intended claimed subject matter. While the steps herein can be presented in a certain order, in some cases the ordering can be changed so that certain inputs are provided at different times or in a different order without changing the function of the systems and methods described. The disclosed procedures could also be executed in different orders. Additionally, various computations that are herein need not be performed in the order disclosed, and other examples using alternative orderings of the computations could be readily implemented. In addition to being reordered, the computations could also be decomposed into sub-computations with the same results.

What is claimed is:

1. A method comprising:
determining historical activity by a user equipment (UE) in a telecommunications network;
mapping, as mapped data, historical signal strength values output by the UE to one or more locations at which the UE performed the historical activity;
determining a current location of the UE;
receiving coverage data indicating network elements of the telecommunications network available to provide services to the UE, a network element of the network elements comprising a set of communication channels associated with different power output levels by the network element;
determining predicted activity by the UE and a predicted location of the UE during the predicted activity;
selecting a communication channel from the set of communication channels for exchanging data between the UE and the network element based at least in part on the mapped data, the current location of the UE, the coverage data, the predicted activity by the UE, and the predicted location of the UE; and
transmitting a message between the UE and the network element based at least in part on the UE using a first power output level that corresponds to a second power output level of the communication channel.

2. The method of claim 1, wherein the UE is a first UE, and the method further comprising:
receiving authorization for the first UE to access the telecommunications network from a second UE,
wherein the first UE includes fewer memory resources, processing resources, or power resources than the second UE.

3. The method of claim 1, wherein the predicted activity includes an amount of data or a type of data associated with an application or a service for use by the UE at a future time, and the method further comprising:
restricting another communication channel in the set of communication channels from being used by the UE based on the predicted activity at the predicted location.

4. The method of claim 1, wherein the UE is a first UE, the communication channel is a first communication channel, and the method further comprising:
receiving signal strength information associated with the network element;
determining that the predicted location of the first UE is outside an area serviced by the network element; and
instructing the first UE to transition from the first communication channel to a second communication channel provided at least in part by a second UE to cause the first UE to report location data to the second UE when the first UE is outside the area serviced by the network element.

5. The method of claim 1, wherein the UE is a first UE, the network element is a first network element, the communication channel is a first communication channel, and the method further comprising:
determining, based at least in part on the coverage data, that the predicted location of the UE is within a boundary of a second network element, the first network element associated with a first range of power output levels and the second network element associated with a second range of power output levels lower than the first range of power output levels; and
determining a second communication channel for the first UE to use at a future time, wherein the second communication channel is provided by a second UE.

6. The method of claim 1, wherein the UE is a first UE and the communication channel is a first communication channel, the message is a first message, and the method further comprising:
sending a second message to a second UE indicating that the first UE is approaching an area without service; and
causing the first UE to receive service using a second communication channel provided by a third UE.

7. A system comprising:
one or more processors; and
memory storing computer-executable instructions that, when executed by the one or more processors, cause the system to perform operations comprising:
determining historical activity by a user equipment (UE) in a telecommunications network;
mapping, as mapped data, historical signal strength values output by the UE to one or more locations at which the UE performed the historical activity;
determining a current location of the UE;
receiving coverage data indicating network elements of the telecommunications network available to provide services to the UE, a network element of the network elements comprising a set of communication channels associated with different power output levels by the network element;
determining predicted activity by the UE and a predicted location of the UE during the predicted activity;
selecting a communication channel from the set of communication channels for exchanging data between the UE and the network element based at least in part on the mapped data, the current location of the UE, the coverage data, the predicted activity by the UE, and the predicted location of the UE; and
transmitting a message between the UE and the network element based at least in part on the UE using a first power output level that corresponds to a second power output level of the communication channel.

8. The system of claim 7, wherein the UE is a first UE, and the operations further comprising:
receiving authorization for the first UE to access the telecommunications network from a second UE,
wherein the first UE includes fewer memory resources, processing resources, or power resources than the second UE.

9. The system of claim 7, wherein the predicted activity includes an amount of data or a type of data associated with an application or a service for use by the UE at a future time, and the operations further comprising:
restricting another communication channel in the set of communication channels from being used by the UE based on the predicted activity at the predicted location.

10. The system of claim 7, wherein the UE is a first UE, the communication channel is a first communication channel, and the operations further comprising:
receiving signal strength information associated with the network element;
determining that the predicted location of the first UE is outside an area serviced by the network element; and
instructing the first UE to transition from the first communication channel to a second communication channel provided at least in part by a second UE to cause the first UE to report location data to the second UE when the first UE is outside the area serviced by the network element.

11. The system of claim 7, wherein the mapping comprises:
receiving the historical signal strength values from the network elements that the UE exchanged activity data with at a previous time;
receiving, from the UE or the network elements, the one or more locations at which the UE exchanged the activity data; and
outputting the mapped data to indicate the historical signal strength values previously used at the one or more locations.

12. The system of claim 7, wherein the UE is a first UE, the network element is a first network element, the communication channel is a first communication channel, and the operations further comprising:
determining, based at least in part on the coverage data, that the predicted location of the UE is within a boundary of a second network element, the first network element associated with a first range of power output levels and the second network element associated with a second range of power output levels lower than the first range of power output levels; and
determining a second communication channel for the first UE to use at a future time, wherein the second communication channel is provided by a second UE.

13. The system of claim 7, the operations further comprising:
configuring the network element to output a predetermined amount of power to transmit data using the communication channel; and
causing the UE to output a corresponding amount of power to exchange the data using the communication channel.

14. The system of claim 7, wherein the UE is a first UE and the operations further comprising:
identifying, based at least in part on the predicted activity by the first UE and the coverage data, an impact to a communication session using the communication channel at a future time;
outputting a list of networks to a second UE having authority to operate the first UE; and
receiving, from the second UE, an indication of a network from the list of networks to maintain the communication session for the first UE at the future time.

15. The system of claim 7, the operations further comprising:
estimating an amount of computational resources for the UE to use the predicted activity; and
selecting the communication channel is further based at least in part on the amount of computational resources for the UE to use the predicted activity.

16. One or more non-transitory computer-readable media storing instructions executable by one or more processors, wherein the instructions, when executed, cause the one or more processors to perform operations comprising:
determining historical activity by a user equipment (UE) in a telecommunications network;
mapping, as mapped data, historical signal strength values output by the UE to one or more locations at which the UE performed the historical activity;
determining a current location of the UE;
receiving coverage data indicating network elements of the telecommunications network available to provide services to the UE, a network element of the network elements comprising a set of communication channels associated with different power output levels by the network element;
determining predicted activity by the UE and a predicted location of the UE during the predicted activity;
selecting a communication channel from the set of communication channels for exchanging data between the UE and the network element based at least in part on the mapped data, the current location of the UE, the coverage data, the predicted activity by the UE, and the predicted location of the UE; and
transmitting a message between the UE and the network element based at least in part on the UE using a first power output level that corresponds to a second power output level of the communication channel.

17. The one or more non-transitory computer-readable media of claim 16, wherein the UE is a first UE, and the operations further comprising:
receiving authorization for the first UE to access the telecommunications network from a second UE,
wherein the first UE includes fewer memory resources, processing resources, or power resources than the second UE.

18. The one or more non-transitory computer-readable media of claim 16, wherein the predicted activity includes an amount of data or a type of data associated with an application or a service for use by the UE at a future time, and the operations further comprising:
restricting another communication channel in the set of communication channels from being used by the UE based on the predicted activity at the predicted location.

19. The one or more non-transitory computer-readable media of claim 16, wherein the UE is a first UE, the communication channel is a first communication channel, and the operations further comprising:
receiving signal strength information associated with the network element;
determining that the predicted location of the first UE is outside an area serviced by the network element; and
instructing the first UE to transition from the first communication channel to a second communication channel provided at least in part by a second UE to cause the first UE to report location data to the second UE when the first UE is outside the area serviced by the network element.

20. The one or more non-transitory computer-readable media of claim 16, wherein the UE is a first UE, the network element is a first network element, the communication channel is a first communication channel, and the operations further comprising:
determining, based at least in part on the coverage data, that the predicted location of the UE is within a boundary of a second network element, the first network element associated with a first range of power output levels and the second network element associated with a second range of power output levels lower than the first range of power output levels; and
determining a second communication channel for the first UE to use at a future time, wherein the second communication channel is provided by a second UE.
